(19) United States
(12) Patent Application Publication
(10) Pub. No.: US 2003/0032757 A1
(43) Pub. Date: Feb. 13, 2003

(54) Polyurethane elastomers having improved abrasion resistance

(76) Inventor: Nai W. Lin, Rochester Hills, MI (US)

Correspondence Address: Patent Counsel, Huntsman Polyurethanes, 286 Mantua Grove Road, West Deptford, NJ, 08066-1732, US

(21) Appl. No.: 10/206,685

(22) Filed: Jul. 26, 2002

Related U.S. Application Data
(60) Provisional application No. 60/309,576, filed on Aug. 2, 2001.

(51) Int. Cl. C08G 18/00

(52) U.S. Cl. 528/44

(57) ABSTRACT

Polyol compositions that can be used to manufacture polyurethane elastomers having improved abrasion resistance, which are particularly suited for use as soles for running shoes. The polyol composition comprises at least two polyols. The first polyol is a linear, hydroxy terminated polyester diol made from: a) ethylene glycol; b) 1,4-butanediol; and c) adipic acid. The second polyol is a slightly branched hydroxy terminated polyester polyol made from: a) ethylene glycol; b) 1,4-butanediol; and c) adipic acid. Polyurethane elastomers, shoe soles made therefrom, and a process for making the polyurethane elastomers are also disclosed.

### CROSS REFERENCE TO RELATED APPLICATIONS

This application claims priority to U.S. Provisional Application, serial No. 60/309,576, which was filed on Aug. 2, 2001.

### FIELD OF THE INVENTION

The present invention relates to polyurethane elastomers having improved abrasion resistance that are prepared from an organic polyisocyanate and a blend or mixture of at least two polyols. The invention also relates to the blend or mixture of the at least two polyols, an isocyanate-reaction system useful in preparing the polyurethane elastomers having improved abrasion resistance, and to the process for preparing the same.

### BACKGROUND OF THE INVENTION

Polyurethane elastomers are typically formed by reacting an A-component, which includes organic polyisocyanate, with a B-component, which includes polyol, blowing agent, catalyst, and a variety of optional additives. This reaction mixture is immediately injected into a mold, where it reacts and cures. Such processes are well known to the skilled artisan.

Polyurethane elastomers are a versatile material and have many uses in the industry. For example, polyurethane elastomers have been used to make shoe soles for many years. Such materials have performed well in many shoe sole applications, such as in work boots, safety boots, fashion shoes, etc. The requirements for shoe sole materials are good physical properties and easy processing. Physical properties of importance include, for example, tensile strength, tear strength, elongation, abrasion resistance, flex properties and hydrolysis resistance.

For most shoe sole applications, known polyurethane elastomers have proven to be acceptable. However, for shoes subject to hitting the ground at high speed and high frequency (and, thus, generating high friction), such as running shoes, rubber has historically been the material of choice for such shoe soles. Under the typical conditions of use, rubber has, until now, always provided better abrasion resistance than known polyurethane elastomers.

Polyether urethanes, polyester urethanes, and their combinations have been, generally, known for making shoe soles. Polyester polyols are typically used for making polyurethane elastomers for high performance shoe soles. Traditionally used polyesters include ethylene glycol adipate polyesters, diethylene glycol adipates, mixed ethylene glycol and diethylene glycol adipates, 1,6-hexanediol adipates and poly-caprolactones. Diethylene glycol adipates and mixed ethylene glycol/diethylene glycol adipates are liquid at room temperature, but result in relatively poor physical properties in the polyurethane elastomer. While 1,4-butanediol and 1,6-hexanediol adipates produce better physical properties, their high melting points can cause processing problems, such as causing the polyol to quickly freeze in re-circulation lines of the two-component urethane processing equipment used in molding shoe soles.

As stated above, rubber has been the shoe sole material of choice for running shoes. However, the use of rubber presents problems inasmuch as the cost of fabricating and attaching a rubber sole to the shoe is more expensive than fabricating and attaching a reactively processed polyurethane elastomer sole. Thus, the art would benefit from a material that provides at least the wear resistance of rubber, and also reduces the cost of manufacturing the shoe. Polyurethane elastomer shoe soles are more cost effective than rubber; however, to date there has not been a polyurethane elastomer material with suitable abrasion resistance compared to rubber, and with processability suitable for 2-component reactive processing.

### SUMMARY OF THE INVENTION

The invention relates to an improved polyol composition that can be used to manufacture polyurethane elastomers having improved abrasion resistance, which is suitable for use as soles for running shoes. The polyol composition comprises at least two polyols. The first polyol is a linear, hydroxy terminated polyester diol made from: a) ethylene glycol; b) 1,4-butanediol; and c) adipic acid. The second polyol is a slightly branched hydroxy terminated polyester polyol made from: a) ethylene glycol; b) 1,4-butanediol; and c) adipic acid.

The invention offers significant advantages in that, among other things, the polyol composition described above remains liquid under processing conditions (i.e., at about 25° C.), whereas known polyester polyol compositions that give the desired polymer properties in the shoe sole are normally solid under processing conditions. Indeed, the polyol composition may remain liquid at room temperature for several days, or even months. The polyol compositions of the invention also meet the desired physical properties in the derived shoe soles.

To form the improved polyurethane elastomer, the above-described polyol composition is reacted with an organic polyisocyanate material. Of course, known blowing agents, catalysts, and other additives may also be supplied to the reaction system. Such processes are well known in the art.

Glossary

Throughout the specification and claims, the following terms shall have the following meaning. Unless otherwise stated all functionalities are number averaged.

1. Black Repitan 99225 is a black pigment available from PAT Products;

2. CATAFOR PU additive is a proprietary antistatic additive having a hydroxyl value of 252, available from Aceto Chemical Company;

3. DABCO® DC 193 surfactant is a proprietary silicone surfactant composition having a hydroxyl value of 76, available from Air Products and Chemicals Corporation;

4. DABCO® EG catalyst is triethylene diamine catalyst in ethylene glycol having a hydroxyl value of 1207, available from Air Products and Chemicals, Inc.;

5. DABCO® S25 catalyst is triethylene diamine catalyst in 1,4-butanediol available from Air Products and Chemicals, Inc.;

6. DALTOREZ™ P716 polyol is a polyester polyol, having a functionality of 2 and a hydroxyl number of 56, which is made from ethylene glycol, diethylene glycol, and adipic acid, available from Huntsman Polyurethanes;

7. DALTOREZ™ P720 diol is a poly (ethylene-butylene) adipate diol having a hydroxyl value of 56, available from Huntsman Polyurethanes;

8. RUCOFLEX® 1037-55 polyol is a polyester polyol having a functionality of 2 and a hydroxyl number of 55, which is made from ethylene glycol, 1,4-butanediol, and adipic acid, available from Ruco Polymers Corp.;

9. RUCOFLEX® S1040-55 polyol is a polyester polyol having a functionality of 2 and a hydroxyl number of 55, which is made from ethylene glycol, 1,4-butanediol, and adipic acid, available from Ruco Polymers Corp.;

10. RUCOFLEX® F 2044 polyol is a polyester polyol having a functionality of 2.2 and a hydroxyl number of 41, which is made of ethylene glycol, 1,4-butanediol, and adipic acid (glycerol branching agent), available from Ruco Polymers Corp.;

11. SUPRASEC® 2000 prepolymer is an MDI prepolymer having an NCO content of 17% by weight and a functionality of 2.02, available from Huntsman Polyurethanes;

12. SUPRASEC® 2980 prepolymer is an MDI prepolymer having an NCO content of 19% by weight and a functionality of 2.02, available from Huntsman Polyurethanes.

13. SUPRASEC® 2981 prepolymer is an MDI prepolymer of a polyester diol available from Huntsman Polyurethanes. The diol is a poly (ethylene-butylene) adipate having a hydroxyl value of 55. It has an NCO group content of 18.9% by weight (relative to the total A-side) and a number averaged isocyanate functionality of between 2.00 and 2.01.

### DETAILED DESCRIPTION AND BEST MODES FOR CARRYING OUT THE INVENTION

The improved polyol compositions of the invention comprise at least two polyols. The first polyol is a linear, hydroxy terminated polyester diol made from a) ethylene glycol; b) 1,4-butanediol; and c) adipic acid. In an aspect of the invention the molar ratio of ethylene glycol: 1,4-butanediol can range from about 30% ethylene glycol: 70% 1,4-butanediol to about 80% ethylene glycol: 20% 1,4-butanediol. One preferred linear hydroxy terminated polyester diol is RUCOFLEX® S1040-55 diol, available from Ruco Polymer Corporation. The second polyol is a slightly branched hydroxy terminated polyester polyol made from a) ethylene glycol; b) 1,4-butanediol; and c) adipic acid. In an aspect of the invention, the molar ratio of ethylene glycol: 1,4-butanediol can range from about 30% ethylene glycol: 70% 1,4-butanediol to about 80% ethylene glycol: 20% 1,4-butanediol. In a further aspect of the invention, the second polyol may have a functionality of from about 2.1 to about 2.6 and preferably about 2.2. Any suitable branching agent may be used; however, glycerol and trimethylolpropane are preferred. One preferred slightly branched hydroxy terminated polyester polyol is RUCOFLEX® F2044 polyol, available from Ruco Polymer Corporation.

For both the first polyol and the second polyol the amount of adipic acid will vary according to the desired molecular weight of the obtained polyol, as one skilled in the art will understand. The preferred MW range for these individual polyester polyols is from about 1400 to 4000, more preferably 2000 to 3000, and most preferably 2000 to 2500.

The two polyols are combined to form the improved polyol composition of the invention. The two polyols can be combined by mixing, blending, stirring, etc. in any suitable manner such as by simple hand mixing, using mechanical mixing devices, or the like. Once combined, the polyol composition may have a number averaged functionality of from about 2.01 to about 2.1, preferably from about 2.01 to about 2.05, and more preferably about 2.05. The polyol composition will typically have a hydroxyl number of from about 40 to about 60, with 50 being preferred. The two polyols can be combined in any suitable weight ratio that results in a liquid composition under process conditions and suitable properties result in the derived elastomers. As used herein “liquid” means there are essentially no separated solids in the composition. In one aspect of the invention, the polyols are combined in weight ratios of first polyol:second polyol of about 75:25. In a further aspect of the invention, the polyol composition should be a stable liquid for at least about 2 hours at about 25° C.; preferably for at least 3 hours at about 25° C., and more preferably for at least about 2 days at about 25° C.

To form the improved polyurethane elastomers of the invention, the polyol composition is reacted with a suitable organic polyisocyanate material to form a polyurethane elastomer. Useful organic polyisocyanate may be any of the aliphatic, cycloaliphatic, araliphatic or aromatic polyisocyanates known to those skilled in the art. Most preferred are those that are liquid at room temperature (25° C.) and having number averaged —NCO functionalities between about 2.00 and about 2.04. Examples of suitable polyisocyanates include 1, 6-hexamethylene diisocyanate, isophorone diisocyanate, 1, 4-cyclohexane diisocyanate, 4, 4′-dicyclohexymethane diisocyanate, 1,5-naphthylene diisocyanate, 1, 4-xylylene diisocyanate, 1,4-phenylene diisocyanate, 2,4-toluene diisocyanate, 2,6-toluene diisocyanate, and the diphenylmethane diisocyanates (“MDI”), including 4,4′-diphenylmethane diisocyanate (“4,4′-MDI”), 2,4′-diphenylmethane diisocyanate (“2,4′-MDI”), 2,2′-diphenylmethane diisocyanate (“2,2′-MDI”), and polymethylene polyphenylene polyisocyanates (“pMDI”), and the like. Mixtures of these polyisocyanates can also be used. Moreover, polyisocyanate variants, i.e., polyisocyanates, especially MDI's, that have been modified in a known manner by the introduction of urethane, allophanate, urea, biuret, carbodiimide, uretonimine, isocyanurate, and/or oxazolidone residues can also be used in the present systems (hereinafter referred to as “MDI variants” or “modified MDI”). These modified polyisocyanates are well known in the art and are prepared by reactions known to the skilled artisan.

In general, aromatic polyisocyanates are preferred. The most preferred aromatic polyisocyanate is diphenylmethane diisocyanate (MDI), for example, the 4,4′-MDI, 2,4′-MDI, low functionality MDI variants, and mixtures thereof.

Most preferably, the polyisocyanate material comprises a liquid MDI prepolymer having number averaged —NCO functionalities of about 2.00 to about 2.04, and preferably about 2.02. Formation of MDI prepolymer materials is well known to the skilled artisan. In such process excess MDI is reacted with a suitable polyol to result in a liquid prepolymer. Although any MDI prepolymer material may be acceptable, preferred MDI prepolymers include, for example, SUPRASEC® 2980, available from Huntsman Polyurethanes. Suitable isocyanates for use as the isocyanate component of the invention can be urethane prepolymers that are stable as liquids at about 25° C. for at least about 1 month.

Suitable MDI prepolymer materials should be liquid and may be polyester and/or polyether prepolymers. Soft block prepolymers may also be utilized, and are generally preferred. In one aspect of the invention, when a MDI prepolymer is used, the MDI prepolymer has a 2,4′-MDI isomer content of less than about 3% by weight. Typically, the MDI prepolymer will have a number averaged functionality of from about 2.00 to about 2.04, and an NCO content of from about 15% to about 23% and more preferably from about 17% to about 19% by weight.

The polyol composition typically is combined (e.g., by mixing) with catalyst, blowing agent and surfactant to form the isocyanate-reactive B-component prior to reacting with the isocyanate material (the A-component), as those skilled in the art will understand.

Although any suitable catalyst may be used, tin catalysts preferably are not used since they may render the polymer susceptible to hydrolysis; however, other metal catalysts may be used. Amine catalysts are preferred. A suitable amine catalyst is triethylene diamine; however, other amine catalysts may be used.

The use of a blowing agent is optional, but when used, the blowing agent is preferably water. Even more preferably water is the sole blowing agent used. The amount of water used may vary, but it is preferred that the water content be less than about 0.1% by weight based on the total weight of the B-component.

Surfactants are not necessary, but may be used. When used, silicone surfactants can be used to improve the surface quality of the obtained elastomer. Suitable silicone surfactants include, for example, DC 200 and DC 193 from Dow Corning.

As will be understood, the A-component (i.e. the isocyanate component) and B-component are combined or mixed together by any suitable method and then either poured or injected into a mold cavity and allowed to react to form the polyurethane elastomer. The relative amounts of A-component and B-component used will depend on the desired properties of the end product.

The B-component may be blended or agitated in a suitable container or supply tank, generally in the range of about 20° C. to about 50° C., although temperatures up to about 75° C. may be employed. Agitation can be conducted using conventional propeller type stirrers (generally supplied by the casting machine manufacturer), usually at rotations per minute of several hundred at most.

The A-component and the B-component are usually placed in separate containers, which are generally equipped with agitators, of the casting machine wherein the temperature of each component is about ambient to about 70° C. Molded polyurethane products are made by providing each of the A-component and the B-component via suitable metering pumps to a mixing head where they are mixed under low pressures, generally pressures less than about 30 bar, preferably less than about 20 bar. The mixed components are then poured or injected into a mold of desired shape.

Once the mold shape has been filled, the mold is closed and curing is effected. Generally, curing temperatures of about 30° C. to about 60° C. are used. Curing (as reflected by demold times) generally requires about 1 to about 30 minutes, usually from about 2 to about 10 minutes. This cure time is ample to allow mixing, foaming if desired, and mold filling, yet sufficiently rapid to allow high rates of production.

In an aspect of the invention, the ratios of the A and B components are such that the Index of the formulation is from about 95 to about 103 and preferably about 96 to about 100. “Index” or “Isocyanate Index” is defined as 100%×(number of —NCO equivalents)/(number of active hydrogen equivalents) in the formulation.

In the utilization of the present process to manufacture polyurethane elastomer shoe soles, each of the two commonly employed sole making processes may be employed. In one process, the left and right foot soles are cast as unit soles, removed from the cast, and then attached to the shoe uppers by a suitable adhesive. In the other process, dual density soles are made via two-step injection. In the first step, the polyurethane system is injected into the closed mold cavity surrounded by an upper mold, a bottom mold and side rings to produce a compact thin layer of outsole elastomer. When the outsole is cured, the upper mold is removed to leave space for making midsole. The shoe upper is present as an outer mold. In the second step, another polyurethane system is injected to produce midsole foam which is between the outsole and shoe upper, and they are glued together.

It has been surprisingly found that by reacting the above-described polyol compositions with an isocyanate, desirable polyurethane elastomer materials are formed. These materials have not only very attractive wear resistance, but are also easily processed, have excellent flex properties, and excellent hydrolysis resistance.

### EXAMPLES

The following examples are provided to illustrate the invention and should not be construed as limiting thereof.

### Example 1

Four elastomer foams were formed by reacting an A-component with a B-component. Comparison Foams 1 and 2 were prepared with polyol compositions not in accordance with the invention. Foam 1 was prepared with a polyol composition according to the invention and with an MDI prepolymer that was formed with a polyol composition that was not made from ethylene glycol, 1,4-butanediol and adipic acid. Foam 2 was prepared with a polyol composition according to the invention and with an MDI prepolymer formed with a polyol composition made from ethylene glycol, 1,4-butanediol and adipic acid. The B-components for each foam are presented in Table 1.

TABLE 1

| | Comparison | Comparison | | |
|---|---|---|---|---|
| Components | Foam 1 | Foam 2 | Foam 1 | Foam 2 |
| Daltorez P-716 | 92.28 | — | — | — |
| Daltorez P-720 | — | 86.020 | — | — |
| RUCOFLEX ® 1040-55 | — | — | 75 | 75 |
| RUCOFLEX ® F 2044 | — | — | 25 | 25 |
| Ethylene Glycol | — | 7.692 | 4.3 | 4.3 |
| 1,4-butandiol | 3.34 | — | — | — |
| Glycerin | 0.1 | — | — | — |
| DABCO ® EG | — | 1.744 | 3.6 | 3.6 |
| DABCO ® S25 | 5.2 | — | — | — |
| DABCO ® DC 193 | — | 0.308 | — | — |
| Water | 0.08 | 0.185 | 0.08 | 0.08 |
| Black Repitan 99225 | 2 | — | 2 | 2 |
| Trimethylolpropane | — | 0.205 | — | — |
| CATAFOR PU | — | 3.846 | — | — |

All components are parts by weight, based on the total weight of the B-component.

Polyurethane elastomer shoe soles were made as follows:

The B-components for Comparison Foam 1 and Foam 1 were reacted with SUPRASEC® 2000 isocyanate in amounts to obtain an Index of 98. The B-components for Comparison Foam 2 were reacted with SUPRASEC® 2981 isocyanate in amounts to obtain an Index of 98. The B-components for Foam 2 were reacted with SUPRASEC® 2980 isocyanate in amounts to obtain an Index of 98. The foams were formed by first mixing together the components to form the B-component and then mixing together the B-component and the A-component to form a reaction mixture, which was then injected into a mold.

Abrasion loss for the polyurethane soles and for a rubber shoe sole were then tested at 2 different conditions for Foams 1 and 2 and for Comparison Foam 1. Specifically, a test apparatus was constructed to simulate actual running conditions. The shoe sole is fixed on a test arm turning at a selected RPM ranging from 20 to 200 RPM. The contact angle of the heel of the sole to the sand belt on the testing apparatus can be adjusted in the range of 20 to 0 degree. The force of the heel hitting the sand belt (controlled by four springs) can range from 188 to 228 pounds. The speed difference between the shoe sole and the sand belt is controlled by two motors. Using the described test apparatus and method, the shoe soles were tested for abrasion loss at two conditions, as outlined in Tables 2 and 3.

TABLE 2
ABRASION LOSS TESTED AT CONDITION 1

| | | Comparsion | | |
|---|---|---|---|---|
| | Rubber | Foam 1 | | |
| | (abrasion | (abrasion | Foam 1 | Foam 2 |
| Cycles | loss in | loss in | (abrasion loss | (abrasion loss |
| (kcs) | grams) | grams) | in grams) | in grams) |
| 5 | 2.86 | 4.3 | 2.79 | 2.09 |
| 10 | 4.89 | 6.77 | 4.31 | 3.66 |
| 15 | 6.55 | 8.45 | 5.38 | 4.9 |
| 20 | 8 | 9.82 | 6.38 | 5.95 |
| 25 | 9.2 | 11.03 | 7.21 | 6.82 |

Test Conditions at Condition 1: Running speed of sole = 78 RPM (equal to 551 ft/min.); Speed difference between sole and belt, belt speed = 46% of sole speed (i.e. speed difference of 253.6 ft/min.); Pressure between sole and belt = 188 to 228 pounds; Contact angle of heel = 20 to 0 degree; and Temperature = 107 to 93° F. for sole and 160 to 126° F. for belt.

TABLE 3
ABRASION LOSS TESTED AT CONDITION 2

| | | Comparsion | Comparison | |
|---|---|---|---|---|
| | Rubber | Foam 1 | Foam 2 | |
| | (abrasion | (abrasion | (abrasion | Foam 1 |
| Cycles | loss in | loss in | loss in | (abrasion loss |
| (kcs) | grams) | grams) | grams) | in grams) |
| 5 | 2.12 | 2.18 | 1.6 | 1.49 |
| 10 | 3.82 | 4 | 3.29 | 2.85 |
| 15 | 4.96 | 5.17 | 4.47 | 3.93 |
| 20 | 6.09 | 5.91 | 5.5 | 4.83 |
| 25 | 7.2 | 6.56 | 6.33 | 5.65 |

Test Conditions at Condition 2: Running speed of sole = 78 RPM (equal to 551 ft/min.); Speed difference between sole and belt, belt speed = 46% of sole speed (i.e. speed difference of 253.6 ft/min.); Pressure between sole and belt = 188 to 228 pounds; Contact angle of heel 16 to 0 degree; and Temperature = 103 to 90° F. for sole and 154 to 120° F. for belt.

Additionally, Comparison Foam 2 was tested for flex fatigue performance. Flex fatigue performance was determined according to the SATRA Test Method PM 133, using the SATRA/Bata Belt Flexing Machine STM 459. A number of samples were prepared from the formulation given in Comparison Foam 2 and these samples survived 40,000 to 45,000 cycles prior to failure (i.e. cracking). Samples formed from the formulations of Foam 1 and Foam 2 consistently survived greater that 50,000 cycles prior to failure.

What is claimed is:

1. A polyol composition for use in the manufacture polyurethane elastomers having improved abrasion resistance comprising:
(a) a linear hydroxy terminated polyester diol made from: ethylene glycol, 1,4-butanediol, and adipic acid, and
(b) a slightly branched hydroxy terminated polyester polyol made from ethylene glycol, 1,4-butanediol, and adipic acid.

2. The composition of claim 1, wherein the linear hydroxy terminated polyester diol and the slightly branched hydroxy terminated polyester polyol each have a molar ratio of ethylene glycol:1,4-butanediol from about 30%:70% to about 80%:20%.

3. The composition of claim 1, wherein the slightly branched hydroxy terminated polyester polyol has a functionality from about 2.1 to about 2.6.

4. The composition of claim 1, wherein the linear hydroxy terminated polyester diol and the slightly branched hydroxy terminated polyester polyol each have a molecular weight between about 1400 to 4000.

5. The composition of claim 1, wherein the composition has a number averaged functionality of from about 2.01 to about 2.1.

6. The composition of claim 1, wherein the composition has a hydroxyl number of from about 40 to about 60.

7. The composition of claim 1, wherein the weight ratio of the linear hydroxy terminated polyester diol:the slightly branched hydroxy terminated polyester polyol is about 75:25.

8. A polyurethane elastomer with improved abrasion resistance comprising the reaction product of:
(a) an organic polyisocyanate, and
(b) a polyol composition comprising:
(i) a linear hydroxy terminated polyester diol made from: ethylene glycol, 1,4-butanediol, and adipic acid, and
(ii) a slightly branched hydroxy terminated polyester polyol made from ethylene glycol, 1,4-butanediol, and adipic acid.

9. The elastomer of claim 8, wherein the organic polyisocyanate is selected from the group consisting of aliphatic, cycloaliphatic, araliphatic, and aromatic polyisocyanates.

10. The elastomer of claim 8, wherein the organic polyisocyanate is selected from the group consisting of 1, 6-hexamethylene diisocyanate, isophorone diisocyanate, 1, 4-cyclohexane diisocyanate, 4, 4′-dicyclohexymethane diisocyanate, 1, 5-naphthylene diisocyanate, 1, 4-xylylene diisocyanate, 1,4-phenylene diisocyanate, 2,4-toluene diisocyanate, 2,6-toluene diisocyanate, diphenylmethane diisocyanates, 4,4′-diphenylmethane diisocyanate, 2,4′-diphenylmethane diisocyanate, 2,2′-diphenylmethane diisocyanate, polymethylene polyphenylene polyisocyanates, and mixtures thereof.

11. The elastomer of claim 8, wherein the organic polyisocyanate has a number averaged —NCO functionality of about 2.00 to about 2.04.

12. The elastomer of claim 8, wherein the polyol composition further comprises a catalyst.

13. The elastomer of claim 12, wherein the catalyst is triethylene diamine.

14. The elastomer of claim 8, wherein the polyol composition further comprises a blowing agent.

15. The elastomer of claim 14, wherein the blowing agent comprises water.

16. The elastomer of claim 8, wherein the polyol composition further comprises a surfactant.

17. The elastomer of claim 8, wherein the linear hydroxy terminated polyester diol and the slightly branched hydroxy terminated polyester polyol each have a molar ratio of ethylene glycol:1,4-butanediol from about 30%:70% to about 80%:20%.

18. The elastomer of claim 8, wherein the slightly branched hydroxy terminated polyester polyol has a functionality from about 2.1 to about 2.6.

19. The elastomer of claim 8, wherein the linear hydroxy terminated polyester diol and the slightly branched hydroxy terminated polyester polyol each have a molecular weight between about 1400 to 4000.

20. The elastomer of claim 8, wherein the polyol composition has a number averaged functionality of from about 2.01 to about 2.1.

21. The elastomer of claim 8, wherein the polyol composition has a hydroxyl number of from about 40 to about 60.

22. The elastomer of claim 8, wherein the weight ratio of the linear hydroxy terminated polyester diol:the slightly branched hydroxy terminated polyester polyol is about 75:25.

23. A process for making a polyurethane elastomer with improved abrasion resistance comprising the step of reacting:
(a) an organic polyisocyanate, and
(b) a polyol composition comprising:
(i) a linear hydroxy terminated polyester diol made from: ethylene glycol, 1,4-butanediol, and adipic acid, and
(ii) a slightly branched hydroxy terminated polyester polyol made from ethylene glycol, 1,4-butanediol, and adipic acid.

24. The process of claim 23, wherein the organic polyisocyanate is selected from the group consisting of 1, 6-hexamethylene diisocyanate, isophorone diisocyanate, 1, 4-cyclohexane diisocyanate, 4, 4′-dicyclohexymethane diisocyanate, 1, 5-naphthylene diisocyanate, 1, 4-xylylene diisocyanate, 1,4-phenylene diisocyanate, 2,4-toluene diisocyanate, 2,6-toluene diisocyanate, diphenylmethane diisocyanates, 4,4′-diphenylmethane diisocyanate, 2,4′-diphenylmethane diisocyanate, 2,2′-diphenylmethane diisocyanate, polymethylene polyphenylene polyisocyanates, and mixtures thereof.

25. The process of claim 23, wherein the polyol composition further comprises a catalyst.

26. The process of claim 25, wherein the catalyst is triethylene diamine.

27. The process of claim 23, wherein the polyol composition further comprises a blowing agent.

28. The process of claim 27, wherein the blowing agent comprises water.

29. The process of claim 23, wherein the polyol composition further comprises a surfactant.

30. The process of claim 23, wherein the linear hydroxy terminated polyester diol and the slightly branched hydroxy terminated polyester polyol each have a molar ratio of ethylene glycol:1,4-butanediol from about 30%:70% to about 80%:20%.

31. The process of claim 23, wherein the slightly branched hydroxy terminated polyester polyol has a functionality from about 2.1 to about 2.6.

32. The process of claim 23, wherein the linear hydroxy terminated polyester diol and the slightly branched hydroxy terminated polyester polyol each have a molecular weight between about 1400 to 4000.

33. The process of claim 23, wherein the polyol composition has a number averaged functionality of from about 2.01 to about 2.1.

34. The process of claim 23, wherein the polyol composition has a hydroxyl number of from about 40 to about 60.

35. The process of claim 23, wherein the weight ratio of the linear hydroxy terminated polyester diol:the slightly branched hydroxy terminated polyester polyol is about 75:25.

36. A shoe sole comprising the reaction product of:
(a) an organic polyisocyanate, and
(b) a polyol composition comprising:
(i) a linear hydroxy terminated polyester diol made from: ethylene glycol, 1,4-butanediol, and adipic acid, and
(ii) a slightly branched hydroxy terminated polyester polyol made from ethylene glycol, 1,4-butanediol, and adipic acid
wherein the shoe sole has improved abrasion resistance.

37. The shoe sole of claim 36, wherein the organic polyisocyanate is selected from the group consisting of 1, 6-hexamethylene diisocyanate, isophorone diisocyanate, 1, 4-cyclohexane diisocyanate, 4, 4′-dicyclohexymethane diisocyanate, 1, 5-naphthylene diisocyanate, 1, 4-xylylene diisocyanate, 1,4-phenylene diisocyanate, 2,4-toluene diisocyanate, 2,6-toluene diisocyanate, diphenylmethane diisocyanates, 4,4′-diphenylmethane diisocyanate, 2,4′-diphenylmethane diisocyanate, 2,2′-diphenylmethane diisocyanate, polymethylene polyphenylene polyisocyanates, and mixtures thereof.

38. The shoe sole of claim 36, wherein the polyol composition further comprises a catalyst.

39. The shoe sole of claim 38, wherein the catalyst is triethylene diamine.

40. The shoe sole of claim 36, wherein the polyol composition further comprises a blowing agent.

41. The shoe sole of claim 40, wherein the blowing agent comprises water.

42. The shoe sole of claim 36, wherein the polyol composition further comprises a surfactant.

43. The shoe sole of claim 36, wherein the linear hydroxy terminated polyester diol and the slightly branched hydroxy terminated polyester polyol each have a molar ratio of ethylene glycol:1,4-butanediol from about 30%:70% to about 80%:20%.
